(19) United States
(12) Patent Application Publication
(10) Pub. No.: US 2018/0242227 A1
(43) Pub. Date: Aug. 23, 2018

(54) CONTROL PLANE DOWNLINK SIGNALING TRANSMISSION METHOD AND SYSTEM

(71) Applicant: ZTE CORPORATION, Shenzhen (CN)

(72) Inventor: Jie ZHAO, Shenzhen (CN)

(21) Appl. No.: 15/751,966

(22) PCT Filed: May 26, 2016
(86) PCT No.: PCT/CN2016/083525

§ 371 Date: Feb. 12, 2018

(30) Foreign Application Priority Data
Aug. 12, 2015 (CN) 201510493869.9

(51) Int. Cl. H04W 48/12; H04W 24/10; H04W 72/04; H04W 76/15; H04W 48/16

(52) U.S. Cl. CPC H04W 48/12; H04W 24/10; H04W 76/27; H04W 76/15; H04W 48/16; H04W 72/0406

(57) ABSTRACT

Technical solutions are described for control plane downlink signaling transmission. An example method includes: determining, by a wireless communication network system, a transmission mode of control plane downlink signaling of user equipment which sends a service request, according to multi-Radio Access Technology (RAT) diversity transmission determination information. The method further includes indicating, by the wireless communication network system, to the user equipment the transmission mode of the control plane downlink signaling.

### CROSS-REFERENCE TO RELATED APPLICATION

This application is the 371 application of PCT Application No. PCT/CN2016/083525, filed May 26, 2016, which is based upon and claims priority to Chinese Patent Application No. 201510493869.9, filed Aug. 12, 2015, the entire contents of which are incorporated herein by reference.

### TECHNICAL FIELD

The present disclosure relates to, but is not limited to, the wireless communication field, and more particularly, to a control plane downlink signaling transmission method and system.

### BACKGROUND

At present, the reason why the wireless communication network cannot guarantee connectivity anytime and anywhere is that the current commercial wireless communication technologies cannot meet user's needs in areas of weak coverage, extreme interference, or overload of network resources. Networks of the future fifth generation mobile communication technology (5G) needs to meet the requirements of the Internet of Things, automotive networks, remote information processing and automation. Due to the lack of assurance of the reliability of the current wireless communication network, there is currently no application in these fields. Ultra-Reliable/Critical MTC (U-Machine Type Communication, U-MTC) is an important goal of 5G networks, which is very different from related human-to-human communication needs. The core requirement of the Ultra-Reliable/Critical MTC is ultra-reliability, ultra-low delay, and relatively low data throughput requirement.

The current architecture features of the second generation mobile communication technologies (2G), the third generation mobile communication technologies (3G) and the fourth generation mobile communication technologies (4G) networks are to meet all business needs in one form of network architecture, and the design goal of the networks is mainly to meet the wireless communication needs of people. However, the goal of 5G networks is to meet the wireless communication needs of things on the basis that 4G networks have met the wireless communication needs of people. This leads to huge changes in technical indexes of different scenarios and different network architecture requirements for different scenarios. One network architecture cannot adapt to all business needs. Meanwhile, the rapid development of Network Function Virtualization (NFV) technology and Software Defined Network (SDN) technology finally led to the reconstruction of 5G network architecture. The 5G networks have the following key features: (1) the networks as a whole are cloudized; (2) the networks can be flexibly sliced (this can support network optimization and network isolation for use case scenarios); (3) network functions and service requirements are formed by arrangement and deployment (different scenarios require different network architectures); and (4) the deployment granularity of the networks is refined from logical entity level to functional component level.

Some current 5G organizations (such as METIS™), which is devoted to researching 5G, have proposed the following features of 5G architectures in some open documents: the 5G networks focus on network functions rather than network entities and/or nodes, the network functions are componentized, functional components are organized based on use cases, and interfaces are defined as interfaces of the functional components rather than interfaces of the network entities.

FIG. 1 is a schematic diagram showing a 5G architecture based on network functions in related arts. As shown in FIG. 1, User Equipment (UE) 110 may access a network for wireless communications by using one or more Radio Access Technologies (RATs) 120, the multiple RAT including: a 5G macro base station, a local data access point, WiFi, and a conventional network. The network may provide application program interfaces 130 for operators, enterprises, etc., and realize the capability opening. In this figure, the dash-dotted line indicates data flow, and the dotted line indicates control information flow.

The functions of 5G are roughly divided into the following parts: Reliable Service Composition (RSC), Central Management Entities (CME), Radio Node Management (RNM), and Air Interface (AI). The above functions may be subdivided into many small functional components, and each small functional component may be deployed in different locations (logical entities) according to needs.

Due to diversified business patterns and scenarios of 5G, 5G needs to have multiple types of cells in order to meet various needs. In terms of network type, there may be 2G, 3G, 4G, 5G cells and wireless networks (Wireless-Fidelity, WiFi) access points (APs) and so on. In terms of coverage, there may be macro cells, micro cells, Ultra Dense Network (UDN) cells and so on. Therefore, there is a problem in fusion (aggregation) of multiple radio access technologies.

This section provides background information related to the present disclosure which is not necessarily prior art.

### SUMMARY

The following is a summary of subject matters of the present disclosure which will be described below in detailed description. The summary is not intended to limit the protection scope as defined by claims.

Embodiments described herein propose a method and system for control plane downlink signaling transmission, which are capable of realizing Ultra-Reliable communication of control plane downlink signaling when a mixed networking is formed using multiple Radio Access Technologies (RATs).

One or more embodiments described herein provide a control plane downlink signaling transmission method, including: determining, by a wireless communication network system, a transmission mode of control plane downlink signaling of user equipment which sends a service request, according to multi-Radio Access Technology (RAT) diversity transmission determination information; and indicating, by the wireless communication network system, to the user equipment the transmission mode of the control plane downlink signaling.

One or more embodiments described herein provide a control plane downlink signaling transmission method, including: receiving, by user equipment, an indication about a transmission mode of control plane downlink signaling from a wireless communication network system, wherein the transmission mode of the control plane downlink signaling is determined by the wireless communication network system according to multi-Radio Access Technology (RAT) diversity transmission determination information; and receiving, by the user equipment, control plane downlink signaling according to the transmission mode of the control plane downlink signaling as indicated by the wireless communication network system.

One or more embodiments described herein provide a control plane downlink signaling transmission system, applied in a wireless communication network system, including: a first resource coordination module configured to, according to multi-Radio Access Technology (RAT) diversity transmission determination information, determine a transmission mode of control plane downlink signaling of user equipment which sends a service request; and a second resource coordination module configured to indicate to the user equipment the transmission mode of the control plane downlink signaling.

One or more embodiments described herein provide a control plane downlink signaling transmission system, including: a first receiving module configured to receive an indication about a transmission mode of control plane downlink signaling from a wireless communication network system, wherein the transmission mode of the control plane downlink signaling is determined by the wireless communication network system according to multi-Radio Access Technology (RAT) diversity transmission determination information; and a second receiving module configured to receive control plane downlink signaling according to the transmission mode of the control plane downlink signaling as indicated by the wireless communication network system.

One or more embodiments described herein provide a computer-readable storage medium for storing computer executable instructions, which are configured to: determine, by a wireless communication network system, a transmission mode of control plane downlink signaling of user equipment which sends a service request, according to multi-Radio Access Technology RAT diversity transmission determination information; and indicate, by the wireless communication network system, to the user equipment the transmission mode of the control plane downlink signaling.

One or more embodiments described herein provide a computer-readable storage medium for storing computer executable instructions, which are configured to: receive, by user equipment, an indication about a transmission mode of control plane downlink signaling from a wireless communication network system, wherein the transmission mode of the control plane downlink signaling is determined by the wireless communication network system according to multi-Radio Access Technology RAT diversity transmission determination information; and receive, by the user equipment, control plane downlink signaling according to the transmission mode of the control plane downlink signaling as indicated by the wireless communication network system.

In the embodiments described herein, the wireless communication network system determines a transmission mode of control plane downlink signaling of user equipment, which sends a service request according to multi-RAT diversity transmission determination information. The wireless communication network system indicates to the user equipment the transmission mode of the control plane downlink signaling. In one or more examples, if a plurality of RATs are used to form a mixed network, URC (Ultra-Reliable Communication) transmission of user control plane downlink signaling can be realized according to users' URC needs. Accordingly, the ultra-reliable communication of the control plane downlink signaling when a plurality of RATs are used to form a mixed network can be realized.

Other aspects will be appreciated after reading and understanding of the drawings and the detailed descriptions.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a schematic diagram showing a 5G architecture based on network functions in related arts.

FIG. 2 is a flowchart showing a control plane downlink signaling transmission method according to one or more embodiments.

FIG. 3 is a flowchart showing a control plane downlink signaling transmission method according to one or more embodiments.

FIG. 4 is a block diagram showing a control plane downlink signaling transmission system applied in a wireless communication network system according to one or more embodiments.

FIG. 5 is a block diagram showing a control plane downlink signaling transmission system applied in user equipment according to one or more embodiments.

FIG. 6 is a schematic diagram showing an application of the one or more embodiments.

FIG. 7 is a flowchart showing an example control plane downlink transmission method according to a one or more embodiments.

FIG. 8 is a flowchart showing another example control plane downlink transmission method according to one or more embodiments.

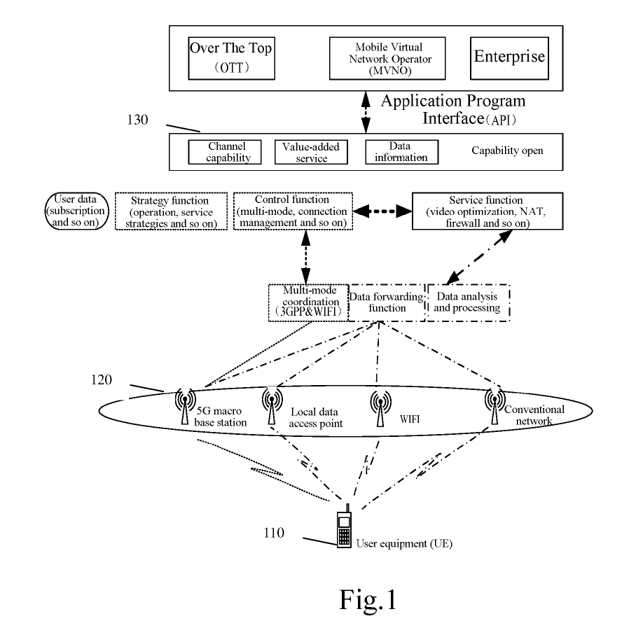

### DETAILED DESCRIPTION

Embodiments are described below with reference to drawings. It should be understood that the embodiments described below are for the purposes of illustrating and explaining the technical solutions provided by the present disclosure, but are not intended to limit the technical solutions.

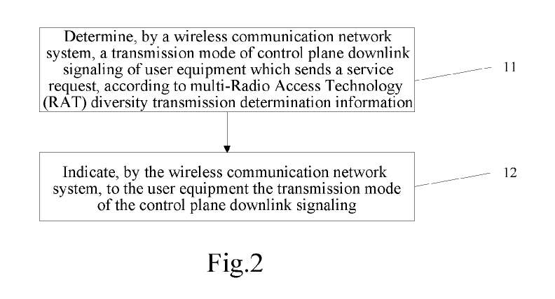

FIG. 2 is a flowchart showing a control plane downlink signaling transmission method according to one or more embodiments. As shown in FIG. 2, the control plane downlink signaling transmission method includes the following steps.

In step 11, according to multi-Radio Access Technology (RAT) diversity transmission determination information, a wireless communication network system determines a transmission mode of control plane downlink signaling of user equipment 110, which sends a service request.

The multi-RAT diversity transmission determination information includes at least one of:

type information of the user equipment 110;

type information of a user who initiates the service request by the user equipment 110;

service type information of the user;

diversity capability information of multi-RAT control plane downlink signaling of the user equipment 110 (capability information may include whether the signaling is capable of copying and transmitting the same signaling data by multi-RATs of the control plane downlink signaling);

measurement report information of the user equipment 110; and

diversity capability information of multi-RAT control plane downlink signaling of the wireless communication network (capability information may include if the network is capable of copying and transmitting the same signaling data by multi-RATs of the control plane downlink signaling).

Before step 11, the method further includes: establishing, by the wireless communication network system, an air interface connection with the user equipment 110 on an RAT, and obtaining at least one of the following kinds of information by this air interface connection:

type information of the user equipment 110;

type information of a user who initiates the service request by the user equipment 110;

service type information of the user; and

diversity capability information of multi-RAT control plane downlink signaling of the user equipment 110.

In addition, after the air interface connection between the user equipment 110 and the wireless communication network system is established on one RAT, the wireless communication network system may request the user equipment 110 to report measurement report information.

In step 12, the wireless communication network system indicates to the user equipment 110 the transmission mode of the control plane downlink signaling.

While the step 12 is performed, the method further includes: reconfiguring, by the wireless communication network system, a Radio Resource Control (RRC) connection of the user equipment 110 according to the determined transmission mode of the control plane downlink signaling of the user equipment 110.

If the determined transmission mode of the control plane downlink signaling of the user equipment 110 is a multi-RAT diversity transmission, the reconfiguring, by the wireless communication network system, of the RRC connection of the user equipment according to the determined transmission mode of the control plane downlink signaling of the user equipment includes:

if the wireless communication network system previously established an air interface connection with the user equipment 110 on only one RAT, the wireless communication network system maintains the air interface connection on this RAT, and newly establishes an air interface connection with the user equipment 110 on at least another RAT; and

if the wireless communication network system previously established air interface connections with the user equipment 110 on at least two RATs, the wireless communication network system maintains an air interface connection on one of the at least two RATs which was previously established with the user equipment 110, deletes an air interface connection on another RAT(s) which was previously established with the user equipment 110, and newly establishes an air interface connection with the user equipment 110 on at least another RAT.

If the determined transmission mode of the control plane downlink signaling of the user equipment 110 is a single-RAT diversity transmission, the reconfiguring, by the wireless communication network system, of the RRC connection of the user equipment 110 according to the determined transmission mode of the control plane downlink signaling of the user equipment 110 includes:

if the wireless communication network system previously established an air interface connection with the user equipment 110 on only one RAT, the wireless communication network system maintains the air interface connection on this RAT; and

if the wireless communication network system previously established air interface connections with the user equipment 110 on at least two RATs, the wireless communication network system maintains an air interface connection on one of the at least two RATs which was previously established with the user equipment 110, and deletes air interface connections on the other RAT(s) which was previously established with the user equipment 110.

Here, if the determined transmission mode of the control plane downlink signaling of the user equipment 110 is the multi-RAT diversity transmission, after the wireless communication network system indicates to the user equipment 110 the transmission mode of the control plane downlink signaling, the method further includes: sending, by the wireless communication network system, to the user equipment 110, the same control plane downlink signaling by the air interface connections on the at least two RATs.

Here, if the determined transmission mode of the control plane downlink signaling of the user equipment 110 is the single-RAT diversity transmission, after the wireless communication network system indicates, to the user equipment 110, the transmission mode of the control plane downlink signaling, the method further includes: sending, by the wireless communication network system, to the user equipment 110 the control plane downlink signaling by the maintained air interface connection on the RAT.

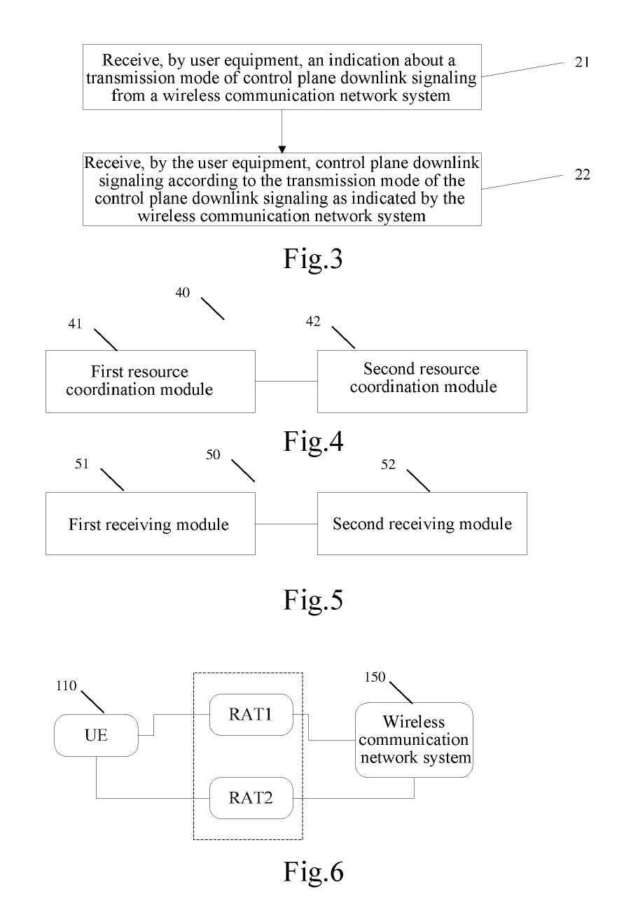

FIG. 3 is a flowchart showing a control plane downlink signaling transmission method according to an embodiment of the present disclosure. As shown in FIG. 3, the control plane downlink signaling transmission method according to the embodiment of the present disclosure includes the following steps.

In step 21, user equipment 110 receives an indication about a transmission mode of control plane downlink signaling from a wireless communication network system. The transmission mode of the control plane downlink signaling is determined by the wireless communication network system according to multi-RAT diversity transmission determination information.

The multi-RAT diversity transmission determination information includes at least one of:

type information of the user equipment 110;

type information of a user who initiates the service request by the user equipment 110;

service type information of the user;

diversity capability information of multi-RAT control plane downlink signaling of the user equipment 110;

measurement report information of the user equipment 110; and

diversity capability information of multi-RAT control plane downlink signaling of the wireless communication network.

Before step 21, the method further includes: establishing, by the user equipment 110, an air interface connection with the wireless communication network system on an RAT, and delivering at least one of the following kinds of information to the wireless communication network system by the air interface connection:

type information of the user equipment 110;

type information of a user who initiates the service request by the user equipment 110;

service type information of the user; and

diversity capability information of multi-RAT control plane downlink signaling of the user equipment 110.

In addition, after the air interface connection between the user equipment 110 and the wireless communication network system is established, the wireless communication network system may ask the user equipment 110 to report measurement report information.

In step 22, the user equipment 110 receives control plane downlink signaling according to the transmission mode of the control plane downlink signaling as indicated by the wireless communication network system.

Here, step 22 includes:

if the transmission mode of the control plane downlink signaling as indicated by the wireless communication network system is a multi-RAT diversity transmission, receiving, by the user equipment 110, the same control plane downlink signaling by air interface connections established on at least two RATs; and

if the transmission mode of the control plane downlink signaling as indicated by the wireless communication network system is a single-RAT diversity transmission, receiving, by the user equipment 110, the control plane downlink signaling by an air interface connection established on one RAT.

After receiving by the user equipment 110 the same control plane downlink signaling by the air interface connections established on at least two RATs, the method further includes: performing, by the user equipment 110, soft combination or selective combination on the received control plane downlink signaling. The soft combination refers to using a combination of the signal data on a plurality of air interfaces. The selective combination refers to selecting and using signal data on an air interface which has a relatively good signal quality based on comparing one or more signal parameters with predetermined values.

According to one or more embodiments, a computer storage medium which has computer executable instructions stored thereon implements the technical solutions described herein, the computer executable instructions being configured to carry out the methods described herein.

In addition, FIG. 4 depicts a control plane downlink signaling transmission system 40 which is applied in a wireless communication network system according to one or more embodiments. The control plane downlink signaling transmission system 40 includes, among other components: a first resource coordination module 41 and a second resource coordination module 42. The first resource coordination module 41 is configured to, according to multi-RAT diversity transmission determination information, determine a transmission mode of control plane downlink signaling of user equipment 110 which sends a service request. The second resource coordination module 42 is configured to indicate to the user equipment 110 the transmission mode of the control plane downlink signaling.

The multi-RAT diversity transmission determination information includes at least one of:

type information of the user equipment 110;

type information of a user who initiates the service request by the user equipment 110;

service type information of the user;

diversity capability information of multi-RAT control plane downlink signaling of the user equipment 110;

measurement report information of the user equipment 110; and

diversity capability information of multi-RAT control plane downlink signaling of the wireless communication network.

Here, the first resource coordination module is further configured to obtain at least one of the following kinds of information by an air interface connection established with the user equipment 110 on an RAT:

type information of the user equipment 110;

type information of a user who initiates the service request by the user equipment 110;

service type information of the user; and

diversity capability information of multi-RAT control plane downlink signaling of the user equipment 110.

Here, the second resource coordination module 42 is further configured to, when indicating to the user equipment 110 the transmission mode of the control plane downlink signaling, reconfigure a Radio Resource Control (RRC) connection of the user equipment 110 according to the determined transmission mode of the control plane downlink signaling of the user equipment 110.

If the determined transmission mode of the control plane downlink signaling of the user equipment 110 is a multi-RAT diversity transmission, the second resource coordination module is configured to reconfigure the RRC connection of the user equipment 110 according to the determined transmission mode of the control plane downlink signaling of the user equipment 110 in the following manner:

if the wireless communication network system previously established an air interface connection with the user equipment 110 on only one RAT, the second resource coordination module maintains the air interface connection on the RAT, and newly establishes an air interface connection with the user equipment 110 on at least another RAT; and

if the wireless communication network system previously established air interface connections with the user equipment 110 on at least two RATs, the second resource coordination module maintains an air interface connection on one of the at least two RATs which was previously established with the user equipment 110, deletes an air interface connection on the other RAT(s) which was previously established with the user equipment 110, and newly establishes an air interface connection with the user equipment 110 on at least another RAT.

If the determined transmission mode of the control plane downlink signaling of the user equipment 110 is a single-RAT diversity transmission, the second resource coordination module reconfigures the RRC connection of the user equipment 110 according to the determined transmission mode of the control plane downlink signaling of the user equipment 110 in the following manner:

if the wireless communication network system previously established an air interface connection with the user equipment 110 on only one RAT, the second resource coordination module maintains the air interface connection on this RAT; or

if the wireless communication network system previously established air interface connections with the user equipment 110 on at least two RATs, the second coordination resource module maintains an air interface connection on one of the at least two RATs which was previously established with the user equipment 110, and deletes air interface connections on other RAT(s) which was previously established with the user equipment.

The system further includes a control plane signaling processing module (not shown) configured to, if the determined transmission mode of the control plane downlink signaling of the user equipment 110 is a multi-RAT diversity transmission, after the second resource coordination module 42 indicates to the user equipment 110 the transmission mode of the control plane downlink signaling, send to the user equipment 110 the same control plane downlink signaling by air interface connections on at least two RATs; and if the determined transmission mode of the control plane downlink signaling of the user equipment 110 is a single-RAT diversity transmission, the control plane signaling processing module is configured to, after the second resource coordination module 42 indicates to the user equipment 110 the transmission mode of the control plane downlink signaling, send to the user equipment 110 the control plane downlink signaling by the maintained air interface connection on the RAT.

In addition, FIG. 5 depicts a control plane downlink signaling transmission system which is applied in user equipment 110 according to one or more embodiments. The control plane downlink signaling transmission system 50 includes: a first receiving module 51 and a second receiving module 52, among other components. The first receiving module 51 is configured to receive an indication about a transmission mode of control plane downlink signaling from a wireless communication network system. The transmission mode of the control plane downlink signaling is determined by the wireless communication network system according to multi-RAT diversity transmission determination information. The second receiving module 52 is configured to receive control plane downlink signaling according to the transmission mode of the control plane downlink signaling as indicated by the wireless communication network system. In practical applications, the first 51 and second 52 receiving modules may be, for example, communication components having a functionality of receiving information.

The multi-RAT diversity transmission determination information includes at least one of:

type information of the user equipment 110;

type information of a user who initiates the service request by the user equipment 110;

service type information of the user;

diversity capability information of multi-RAT control plane downlink signaling of the user equipment 110;

measurement report information of the user equipment 110; and

diversity capability information of multi-RAT control plane downlink signaling of the wireless communication network.

Here, the system further includes: a connection module (not shown) configured to establish an air interface connection with the wireless communication network system on an RAT.

Here, the second receiving module 52 is configured to:

if the transmission mode of the control plane downlink signaling as indicated by the wireless communication network system is a multi-RAT diversity transmission, receive the same control plane downlink signaling by air interface connections established on at least two RATs; and

if the transmission mode of the control plane downlink signaling as indicated by the wireless communication network system is a single-RAT diversity transmission, receive the control plane downlink signaling by an air interface connection established on one RAT.

The system 50 further includes: a processing module (not shown) configured to, after the second receiving module 52 receives the same control plane downlink signaling by air interface connections established on at least two RATs, perform soft combination or selective combination on the received control plane downlink signaling. In practical applications, the processing module may be, for example, a processor or other element having a functionality of information processing.

In addition, the specific processing flows of the above system 50 are the same as those of the described methods, and repeated descriptions are omitted here.

FIG. 6 is a schematic diagram showing an application of the embodiments of the present disclosure. As shown in FIG. 6, for example, User Equipment (UE) 110 may establish an air interface connection with a wireless communication network system 150 on RAT1; the wireless communication network system 150 obtains at least one of the following kinds of information via the air interface connection on RAT1: type information of the user equipment 110, type information of a user, service type information of the user, and diversity capability information of multi-RAT control plane downlink signaling of the user equipment 110; the user equipment may 110 initiate a service request; if the wireless communication network system 150 determines according to the multi-RAT diversity transmission determination information to transmit the control plane downlink signaling using a multi-RAT diversity transmission (i.e., transmit the same control plane downlink signaling by different RATs), the wireless communication network system 150 reconfigures the RRC connection of the user equipment 110 by the air interface connection on RAT1, and indicates that the control plane downlink signaling is transmitted by a multi-RAT diversity transmission mode. Specifically, if there is currently an air interface connection between the wireless communication network system 150 and the user equipment 110 only on RAT1, the wireless communication network system 150 maintains the air interface connection on RAT1, and newly establishes an air interface connection on RAT2. Alternatively, if there are currently air interface connections between the wireless communication network system 150 and the user equipment 110 on RAT1 and RAT2, the wireless communication network system 150 maintains the air interface connection on RAT1, deletes the air interface connection on RAT2, and newly establishes an air interface connection on RATS. The present disclosure does not impose specific limitations on this. In practical applications, the reconfigurations may be determined depending on actual RAT conditions. For example, the wireless communication network system 150 transmits the same control plane downlink signaling by the air interface connection on RAT1 and the air interface connection on RAT2, or transmits the same control plane downlink signaling by the air interface connection on RAT1 and the air interface connection on RATS. The user equipment 110 receives the same control plane downlink signaling sent by the air interface connections on different RATs, and then performs soft combination or selective combination on the received control plane downlink signaling.

When the wireless communication network system 150 determines according to the multi-RAT diversity transmission determination information to transmit the control plane downlink signaling by a single-RAT transmission mode, if the current transmission mode of the control plane downlink signaling is a multi-RAT diversity transmission mode (for example, the control plane downlink signaling is transmitted by the air interface connections on RAT1 and RAT2), the wireless communication network system 150 reconfigures the RRC connection of the user equipment 110 (for example, to maintain the air interface connection on RAT1 and delete the air interface connection on RAT2), and indicates that the control plane downlink signaling is transmitted by the single-RAT transmission mode. For example, the wireless communication network system 150 transmits the control plane downlink signaling to the user equipment 110 by the air interface connection on RAT1. If the current transmission mode of the control plane downlink signaling is the single-RAT diversity transmission mode (for example, the control plane downlink signaling is transmitted by the air interface connection on RAT1), no action is needed, and the wireless communication network system 150 transmits the control plane downlink signaling to the user equipment 110 by the air interface connection on RAT1. The user equipment 110 receives and processes the control plane downlink signaling which is sent by the air interface connection on RAT 1, and no diversity gain is needed.

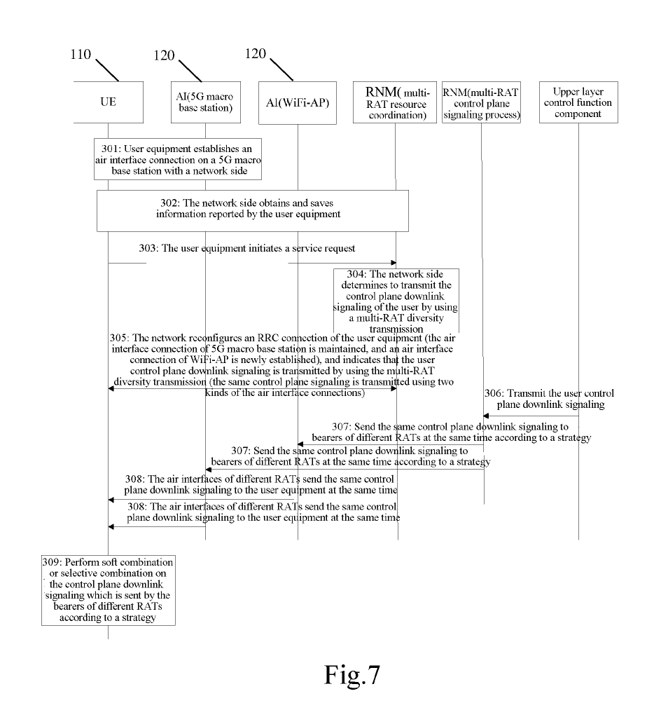

FIG. 7 is a flowchart for an example method for a control plane downlink signaling transmission according to one or more embodiments. Here, an Ultra-reliable/Critical MTC (U-MTC) scenario in industrial control of plants is used, and accessing of different RATs, such as a 5G macro base station, WiFi-AP and so on, are deployed in the 5G network. Furthermore, the wireless communication requirements such as ultra-reliability and ultra-low delay have to be met.

In one or more examples, an RNM for coordination of multi-RAT resources is used for receiving a service request from user equipment 110 and determining the transmission mode of the control plane downlink signaling of the user equipment. For example, an RNM for processing multi-RAT control plane signaling is used for sending, by an air interface connection on an RAT, the control plane downlink signaling which is received from an upper layer control functional component to the user equipment 110. Here, the RNM for coordination of multi-RAT resources, the RNM for processing the multi-RAT control plane signaling, and the upper layer control functional component all refer to functional components and may be deployed in different logic entities depending on scenarios. For example, in a tight coupling mode, the RNM for coordination of multi-RAT resources and the RNM for processing multi-RAT control plane signaling may be deployed in the 5G macro base station. In a loose coupling mode, the RNM for coordination of multi-RAT resources and the RNM for processing multi-RAT control plane signaling may be deployed in an independent local gateway.

As shown in FIG. 7, the example method includes at least the follow steps.

In step 301, User Equipment (UE) 110 establishes an air interface (hereinafter referred to as AI) connection on a 5G macro base station with a network side, and delivers information to the network side. The information includes: type information of the user equipment 110 (for example, industrial control user equipment type), diversity capability information of multi-RAT control plane downlink signaling of the user equipment 110 (for example, the user equipment supports the diversity transmission of the multi-RAT control plane downlink signaling of the 5G macro base station and WiFi-AP).

In step 302, the network side obtains and saves the information reported by the user equipment 110.

In step 303, the user equipment 110 initiates a service request.

In step 304, after receiving the service request from the user equipment 110, the network side determines to transmit the control plane downlink signaling of the user by using a multi-RAT diversity transmission (i.e., to transmit the same control plane downlink signaling by different RATs) according to type information of the user equipment 110 (for example, the user equipment is of an industrial control type), the diversity capability information of the multi-RAT control plane downlink signaling of the user equipment 110 (for example, supporting the diversity transmission of the multi-RAT control plane downlink signaling of the 5G macro base station and WiFi-AP), diversity capability information of the multi-RAT control plane downlink signaling of the wireless communication network (for example, the area where the UE 100 is located is covered by the 5G macro base station and WiFi-AP, and the network supports the diversity transmission of the multi-RAT control plane downlink signaling of the 5G macro base station and WiFi-AP). This can improve the reliability and reduce a time delay.

In step 305, the network side reconfigures an RRC connection of the user equipment 110 (for example, maintaining the AI connection on the 5G macro base station, and newly establishing an AI connection on the WiFi-AP), and indicates that the user control plane downlink signaling is transmitted by using the multi-RAT diversity transmission (i.e., the same control plane downlink signaling is transmitted by the AI connection on the 5G macro base station and the AI connection on WiFi-AP).

In step 306, the upper layer control functional component transmits the user control plane downlink signaling to the RNM for processing the multi-RAT control plane signaling.

In step 307, the RNM for processing the multi-RAT control plane signaling sends the same control plane downlink signaling to bearers of different RATs at the same time according to a strategy.

In step 308, the AIs of different RATs send the same control plane downlink signaling to the user equipment 110 at substantially the same time.

In step 309, the user equipment 110receives the same user control plane downlink signaling which is sent by AIs of different RATs, and then performs soft combination or selective combination on the received user control plane downlink signaling according to a strategy.

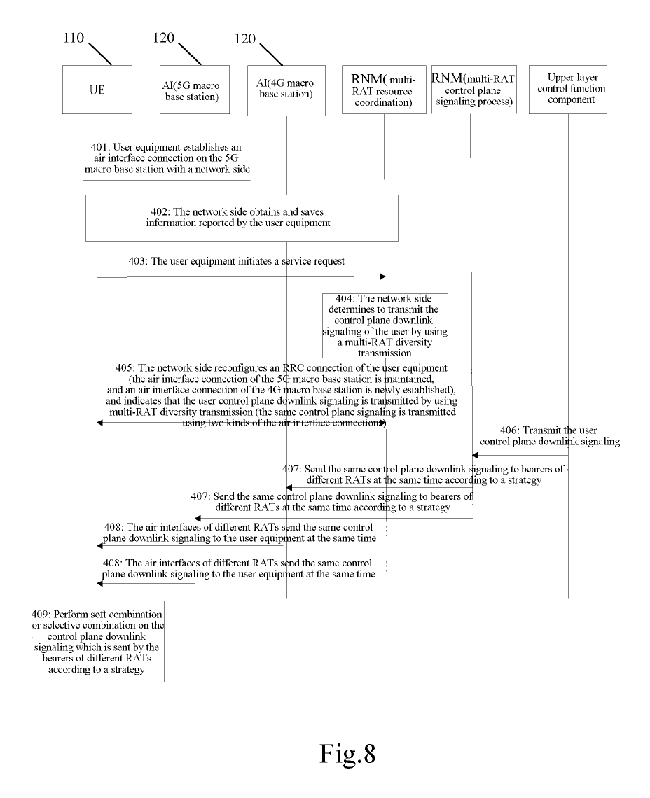

FIG. 8 is a flowchart showing an example method for a control plane downlink signaling transmission according to one or more embodiments. Here, an Ultra-reliable/Critical MTC (U-MTC) scenario in smart power grid control is used, the network is deployed with access of different RATs, for example, a 5G macro base station, a 4G macro base station and so on, the 4G network provides a basic coverage, and the 5G network provides a hot spot enhanced coverage. Furthermore, the wireless communication requirements such as ultra-reliability and ultra-low delay have to be met.

In this embodiment, for example, an RNM for coordination of multi-RAT resources is used for receiving a service request from user equipment 110 and determining the transmission mode of the control plane downlink signaling of the user equipment 110. For example, an RNM for processing multi-RAT control plane signaling is used for sending, by an air interface connection on an RAT, the control plane downlink signaling which is received from an upper layer control functional component to the user equipment 110. The RNM for coordination of multi-RAT resources, the RNM for processing the multi-RAT control plane signaling, and the upper layer control functional component are all functional components and may be deployed in different logic entities depending on scenarios. For example, in a tight coupling mode, the RNM for coordination of multi-RAT resources and the RNM for processing multi-RAT control plane signaling may be deployed in the 5G macro base station. In a loose coupling mode, the RNM for coordination of multi-RAT resources and the RNM for processing multi-RAT control plane signaling may be deployed in an independent local gateway.

As shown in FIG. 8, the method includes at least the following steps.

In step 401, User Equipment (UE) 110 establishes an AI connection on a 5G macro base station 120 with a network side, and delivers information to the network side. The information includes: type information of the user equipment 110 (for example, the user equipment is of a smart power grid control type), diversity capability information of multi-RAT control plane downlink signaling of the user equipment 110 (for example, the capability of the user equipment 110 supports the diversity transmission of the multi-RAT control plane downlink signaling of the 5G macro base station 120 and 4G macro base station 120).

In step 402, the network side obtains and saves the information reported by the user equipment 110.

In step 403, the user equipment 110 initiates a service request.

In step 404, after receiving the service request from the user, the network side determines to transmit the control plane downlink signaling of the user by using a multi-RAT diversity transmission (i.e., to transmit the same control plane downlink signaling by different RATs) according to the type information of the user equipment (for example, the user equipment is of a smart power grid control type), the diversity capability information of the multi-RAT control plane downlink signaling of the user equipment 110 (for example, the capability of the user equipment supports the diversity transmission of the multi-RAT control plane downlink signaling of the 5G macro base station 120 and the 4G macro base station 120), the diversity capability information of the multi-RAT control plane downlink signaling of the wireless communication network (for example, the area where the UE is located is covered by the 5G macro base station and the 4G macro base station, and the network supports the diversity transmission of the multi-RAT control plane downlink signaling of the 5G macro base station 120 and the 4G macro base station 120). This can improve the reliability and reduce delay.

In step 405, the network side reconfigures an RRC connection of the user equipment 110 (for example, the network side maintains the AI connection on the 5G macro base station 120, and newly establishes an AI connection on the 4G macro base station 120), and indicates that the user control plane downlink signaling is transmitted by using multi-RAT diversity transmission (i.e., the same control plane downlink signaling is transmitted by the AI connection on the 5G macro base station 120 and the AI connection on the 4G macro base station 120).

In step 406, the upper layer control functional component transmits the user control plane downlink signaling to the RNM for processing the multi-RAT control plane signaling.

In step 407, the RNM for processing the multi-RAT control plane signaling sends the same control plane downlink signaling to bearers of different RATs at substantially the same time according to a strategy.

In step 408, the AIs of different RATs send the same control plane downlink signaling to the user equipment 110 at substantially the same time.

In step 409, the user equipment 110 receives the same user control plane downlink signaling which is sent by AIs of different RATs, and performs soft combination or selective combination on the received user control plane downlink signaling according to a strategy.

One of ordinary skill in the art may understand that all or a part of the steps in the foregoing methods may be implemented by a program instructing relevant hardware (for example, a processor), and the program may be stored in a computer-readable storage medium, such as a read-only memory, a magnetic disk, or an optical disk or the like. Optionally, all or a part of the steps of the above embodiments may also be implemented by using one or more integrated circuits. Correspondingly, each module/unit in the above embodiments can be implemented in the form of hardware, for example, integrated circuits can be used to realize corresponding functions; or, each module/unit can be implemented in the form of software function module, for example, the processor executes the program/instructions stored in the memory to achieve corresponding functions. The present disclosure is not limited to any particular form of combination of hardware and software.

One of ordinary skill in the art should understand that modifications or equivalent substitutions may be made to the technical solutions of the present disclosure without departing from the spirit and scope of the technical solutions of the present disclosure, and such modifications or equivalent substitutions fall within the scope of the present disclosure as defined by appended claims.

### INDUSTRIAL APPLICABILITY

By the above technical solutions, if a plurality of RATs are used for mixed networking, URC transmission of user control plane downlink signaling can be realized according to the user's URC needs. Thus, the ultra-reliable communication of the control plane downlink signaling when a plurality of RATs are used to form a mixed network can be realized.

1.-26. (canceled)

27. A control plane downlink signaling transmission method, comprising:
determining, by a wireless communication network system, a transmission mode of control plane downlink signaling of user equipment which sends a service request, according to multi-Radio Access Technology (RAT) diversity transmission determination information; and
indicating, by the wireless communication network system, to the user equipment the transmission mode of the control plane downlink signaling.

28. The method according to claim 27, wherein the multi-RAT diversity transmission determination information comprises at least one of:
type information of the user equipment;
type information of a user who initiates the service request by the user equipment;
service type information of the user;
diversity capability information of multi-RAT control plane downlink signaling of the user equipment;
measurement report information of the user equipment; and
diversity capability information of multi-RAT control plane downlink signaling of the wireless communication network.

29. The method according to claim 27, further comprising:
before determining, by the wireless communication network system, the transmission mode of control plane downlink signaling of the user equipment which sends the service request according to the multi-RAT diversity transmission determination information, establishing, by the wireless communication network system, an air interface connection with the user equipment on an RAT, and obtaining at least one of following kinds of information by the air interface connection:
type information of the user equipment;
type information of a user who initiates the service request by the user equipment;
service type information of the user; and
diversity capability information of multi-RAT control plane downlink signaling of the user equipment.

30. The method according to claim 27, further comprising:
when indicating, by the wireless communication network system, to the user equipment the transmission mode of the control plane downlink signaling, reconfiguring, by the wireless communication network system, a Radio Resource Control (RRC) connection of the user equipment according to the determined transmission mode of the control plane downlink signaling of the user equipment.

31. The method according to claim 30, wherein when the determined transmission mode of the control plane downlink signaling of the user equipment is a single-RAT diversity transmission, the reconfiguring, by the wireless communication network system, the RRC connection of the user equipment according to the determined transmission mode of the control plane downlink signaling of the user equipment comprises:
in response to the wireless communication network system previously establishing an air interface connection with the user equipment on a single RAT, maintaining, by the wireless communication network system, the air interface connection on the single RAT; and
in response to the wireless communication network system previously establishing air interface connections with the user equipment on at least two RATs, maintaining an air interface connection on one of the at least two RATs which was previously established with the user equipment and deleting air interface connections on the other RAT(s) which were previously established with the user equipment by the wireless communication network system.

32. The method according to claim 31, further comprising:
in response to the determined transmission mode of the control plane downlink signaling of the user equipment being the single-RAT diversity transmission, after the wireless communication network system indicates to the user equipment the transmission mode of the control plane downlink signaling, sending, by the wireless communication network system, to the user equipment, the control plane downlink signaling by the maintained air interface connection on the single RAT.

33. A control plane downlink signaling transmission method, comprising:
receiving, by user equipment, an indication about a transmission mode of control plane downlink signaling from a wireless communication network system, the transmission mode of the control plane downlink signaling is determined by the wireless communication network system according to multi-Radio Access Technology (RAT) diversity transmission determination information; and
receiving, by the user equipment, control plane downlink signaling according to the transmission mode of the control plane downlink signaling as indicated by the wireless communication network system.

34. The method according to claim 33, wherein the multi-RAT diversity transmission determination information comprises at least one of:
type information of the user equipment;
type information of a user who initiates the service request by the user equipment;
service type information of the user;
diversity capability information of multi-RAT control plane downlink signaling of the user equipment;
measurement report information of the user equipment; and
diversity capability information of multi-RAT control plane downlink signaling of the wireless communication network.

35. The method according to claim 33, further comprising:
before the user equipment receives the indication about the transmission mode of the control plane downlink signaling from the wireless communication network system, establishing an air interface connection with the wireless communication network system on a RAT and delivering at least one of following kinds of information to the wireless communication network system via the air interface connection by the user equipment:
type information of the user equipment;
type information of a user who initiates the service request by the user equipment;
service type information of the user; and
diversity capability information of multi-RAT control plane downlink signaling of the user equipment.

36. The method according to claim 33, wherein the receiving, by the user equipment, control plane downlink signaling according to the transmission mode of the control plane downlink signaling as indicated by the wireless communication network system comprises:
in response to the transmission mode of the control plane downlink signaling as indicated by the wireless communication network system being a multi-RAT diversity transmission, receiving, by the user equipment, the same control plane downlink signaling by air interface connections established on at least two RATs; and
in response to the transmission mode of the control plane downlink signaling as indicated by the wireless communication network system being a single-RAT diversity transmission, receiving, by the user equipment, the control plane downlink signaling by an air interface connection established on a single RAT.

37. The method according to claim 36, further comprising:
after receiving by the user equipment the same control plane downlink signaling by the air interface connections established on at least two RATs, performing, by the user equipment, soft combination or selective combination on the received control plane downlink signaling.

38. A control plane downlink signaling transmission system, applied in a wireless communication network system, comprising:
a processor; and
a memory for storing instructions executable by the processor;
wherein the processor is configured to:
according to multi-Radio Access Technology (RAT) diversity transmission determination information, determine a transmission mode of control plane downlink signaling of user equipment which sends a service request; and
indicate to the user equipment the transmission mode of the control plane downlink signaling.

39. The system according to claim 38, wherein the multi-RAT diversity transmission determination information comprises at least one of:
type information of the user equipment;
type information of a user who initiates the service request by the user equipment;
service type information of the user;
diversity capability information of multi-RAT control plane downlink signaling of the user equipment;
measurement report information of the user equipment; and
diversity capability information of multi-RAT control plane downlink signaling of the wireless communication network.

40. The system according to claim 38, wherein the processor is further configured to obtain at least one of following kinds of information by an air interface connection established with the user equipment on an RAT:
type information of the user equipment;
type information of a user who initiates the service request by the user equipment;
service type information of the user; and
diversity capability information of multi-RAT control plane downlink signaling of the user equipment.

41. The system according to claim 38, wherein the processor is further configured to, when indicating to the user equipment the transmission mode of the control plane downlink signaling, reconfigure a Radio Resource Control (RRC) connection of the user equipment according to the determined transmission mode of the control plane downlink signaling of the user equipment.

42. A control plane downlink signaling transmission system, applied to a device used as a user equipment, the control plane downlink signaling transmission system comprising:
a processor; and
a memory for storing instructions executable by the processor;
wherein the processor is configured to:
receive indication about a transmission mode of control plane downlink signaling from a wireless communication network system, wherein the transmission mode of the control plane downlink signaling is determined by the wireless communication network system according to multi-Radio Access Technology (RAT) diversity transmission determination information; and
receive control plane downlink signaling according to the transmission mode of the control plane downlink signaling as indicated by the wireless communication network system.

43. The system according to claim 42, wherein the multi-RAT diversity transmission determination information comprises at least one of:
type information of the user equipment;
type information of a user who initiates the service request by the user equipment;
service type information of the user;
diversity capability information of multi-RAT control plane downlink signaling of the user equipment;
measurement report information of the user equipment; and
diversity capability information of multi-RAT control plane downlink signaling of the wireless communication network.

44. The system according to claim 42, wherein the processor is further configured to:
establish an air interface connection with the wireless communication network system on an RAT.

45. The system according to claim 42, wherein the processor is further configured to:
when the transmission mode of the control plane downlink signaling as indicated by the wireless communication network system is a multi-RAT diversity transmission, receive the same control plane downlink signaling by air interface connections established on at least two RATs; and
when the transmission mode of the control plane downlink signaling as indicated by the wireless communication network system is a single-RAT diversity transmission, receive the control plane downlink signaling by an air interface connection established on single RAT.

46. The system according to claim 45, wherein the processor is further configured to: after receiving the same control plane downlink signaling by air interface connections established on the at least two RATs, perform soft combination or selective combination on the received control plane downlink signaling.
